(19) United States
(12) Patent Application Publication
(10) Pub. No.: US 2009/0205591 A1
(43) Pub. Date: Aug. 20, 2009

(54) Internal Combustion Engine

(76) Inventor: Ian John Shand, Hampshire (GB)

Correspondence Address: Manelli Denison & Selter;Attn: William H. Bollman, 2000 M Street, NW, 7th Floor, Washington, DC, 20036, US

(21) Appl. No.: 11/886,743

(22) PCT Filed: Sep. 9, 2005
(86) PCT No.: PCT/GB2005/003500

§ 371 Date: Jan. 21, 2009

(30) Foreign Application Priority Data
Mar. 21, 2005 (GB) 0505626.2

(51) Int. Cl. F02B 75/22; F02F 1/00

(52) U.S. Cl. 123/54.4; 123/193.2

(57) ABSTRACT

A v-twin type engine (20) according to the present invention comprises an engine (20) comprising a single cylinder block (22) and a crankcase (23). The cylinder block (22) is formed with two cylinders (26, 28) and a lower connection region (24) adapted to be attachable to the crankcase (23) of the engine (20). Disposed at the top of each cylinder (26, 28) there is a cylinder head (30, 32). The lower connecting region (24) is formed with a flange (34) that extends around the lower perimeter of the cylinder block (22). The flange (34) is received by an opening (36) formed in the crankcase (23). It will be appreciated that the flange (34) will follow the contours of the opening (36) and the crankcase (23). The flange (34) forms a seal with the crankcase (23).

The invention relates to an internal combustion engine and is concerned particularly, although not exclusively, with a cylinder and gearbox housing for a v-type motorcycle engine.

The invention is designed especially for a v-twin motorcycle engine, but it may be applied to any internal combustion engine.

### BACKGROUND OF THE INVENTION

The present known motorcycle engines comprise singe cylinder and multi-cylinder internal combustion engines. The multi-cylinder engines may comprise a cylinder block formed with a row of parallel cylinders or alternatively they may comprise a v-type cylinder block formed with two rows of cylinders.

Known v-type cylinder blocks are used on the Harley Davidson™ range of motorcycles. In particular, the range of engines includes engines which comprise v-twin cylinders.

The capacities of the known v-twin engines are limited to the amount of cubic centimeters of the inner volume of the cylinders. A typical 45 degree air cooled v-twin comprises a pair of separate cylinder castings which are each attached to the crankcase by number of cylinder bolts which extend through a cylinder head and the body of a cylinder and bolt into the crankcase. The two connecting rods of the engine co-operate with a common crank pin. Reciprocating within the cylinders are respective pistons. The arrangement of the timing of the pistons is such that they both reach the top dead centre stroke at the same time and they both reach the bottom dead centre stroke at the same time and when the crank shaft is at 0 degrees, 180 degrees and 360 degrees respectively. At these positions the lowermost regions of the respective pistons converge towards each other to such an extent that some pistons may require a cutout section formed in the lower skirt to avoid the pistons contacting.

According to the known prior art, in order to increase the capacity of a standard v-twin engine there can be two types of modification. The first type of modification involves increasing the length of the stroke of the cylinder from bottom dead centre to top dead centre. However, this type of modification will mean that the revolution of the engine will decrease, the velocities are increased and the overall height of the engine is increased. Having an increased overall height will cause problems when trying to fit the engine into a standard frame. The second type of modification involves the cylinder sleeve being bored out to increase the diameter of the cylinder and therefore the capacity. However, there is a limited amount of cylinder sleeve that may be removed and then it is necessary to raise the deck height but this again makes the overall height of the engine taller.

The present invention sets out to overcome the problems of the known modifications to a standard v-twin engine by providing larger capacities and displacements whilst maintaining the overall standard appearance of the engine.

### DISCLOSURE OF THE INVENTION

According to a first aspect of the present invention there is provided a v-twin cylinder block for a motorcycle engine comprising a crankcase, the v-twin cylinder block comprising a single block formed with two cylinders and a lower connection region adapted to be attachable to the crankcase of the engine.

By attaching the lower region of the cylinder block to the crankcase there is no requirement to have connecting rods extending the whole length of the cylinder. Therefore, the diameter of the cylinders may be increased.

It is preferable that the lower connection region is disposed around an opening formed in the cylinder block.

Preferably, the lower connection region is adapted to be received by an opening formed in the crankcase of the engine.

Preferably, the v-twin cylinder block is attachable to the crankcase by means disposed at the lower connection region.

Preferably, the cylinders of v-twin cylinder block are formed at a 45 degree angle to each other.

The lower connection region preferably comprises a flange that extends outwardly from the lower perimeter of the cylinder block.

The cylinder block is preferably a single casting formed from a metal material.

Each cylinder of the cylinder block preferably comprises a cylinder head part which is securable to the uppermost end of the respective cylinders.

Each cylinder head part is preferably secured to the respective cylinder by a series of removable securing elements which extend partially through the cylinder block.

According to a second aspect of the present invention there is provided a crankcase for a motorcycle engine comprising a v-twin cylinder block according to the first aspect of the present invention, the crankcase being formed with an opening adapted to receive, and adapted to be attachable to, the lower region of the cylinder block.

Preferably, the opening is substantially a rectangular shape which follows the contours of the crankcase.

According to a third aspect of the present invention there is provided an engine comprising a v-type cylinder block and a crankcase, the v-type cylinder block comprising a single block formed with two cylinders and a lower connection region adapted to be received by an opening formed in the crankcase of the engine.

The present invention may be used on a v-type engine comprising a plurality of v-twin cylinders.

According to a fourth aspect of the present invention there is provided a method for adapting a standard v-type engine and increasing the capacity of the standard engine and maintaining the standard stroke length of the cylinder, wherein the method comprises replacing the individual cylinders with a single cylinder block formed with the respective cylinders.

The method preferably comprises the step of increasing the cylinder bore size while maintaining the stroke length of the pistons.

It shall be appreciated that the present invention may be used for engines other than v-type engines which are used in other types of vehicles or for engines used as general power units.

According to a fifth aspect of the present invention there is provided an engine comprising a cylinder block and a crankcase, the v- cylinder block comprising a single block formed with two cylinders and a lower connection region adapted to be received by an opening formed in the crankcase of the engine.

It shall be appreciated that one or more of the features described above regarding the second, third and fourth aspects of the invention are used in conjunction with the features of the first aspect of the invention. It shall also be appreciated that the invention may also comprise one or more of the features described below and/or shown in the accompanying Figures.

### BRIEF DESCRIPTION OF THE DRAWINGS

Specific embodiments of the invention and variants thereof will now be described by way of example only with reference to the accompanying drawing, in which:

FIG. 1 is a schematic isometric view of a known v-twin engine and shows two separate cylinder castings disassembled from a crankcase;

FIG. 2 is a first side view elevation of a v-twin engine according to the present invention;

FIG. 3 is a second side view of the v-twin engine shown in FIG. 2;

FIG. 4 is a schematic isometric view of the cylinders and crankcase of the v-twin engine shown in FIGS. 2 and 3 and shows the cylinders disassembled;

FIG. 5 is a view of a vertical cross-section through the cylinders of the known engine shown in FIG. 1; and

FIG. 6 is a view of a vertical cross-section through the cylinders of the engine shown in FIGS. 2 to 4 with the cylinder heads removed.

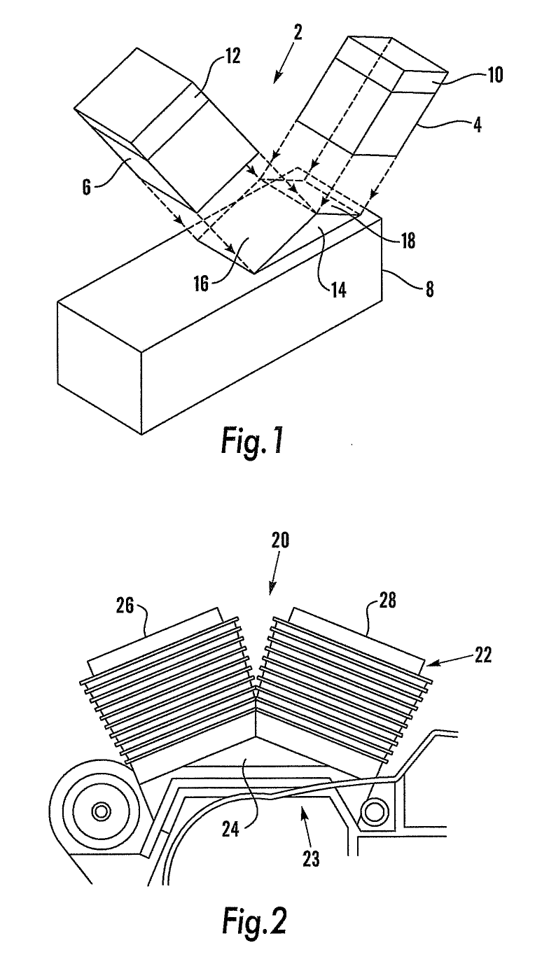

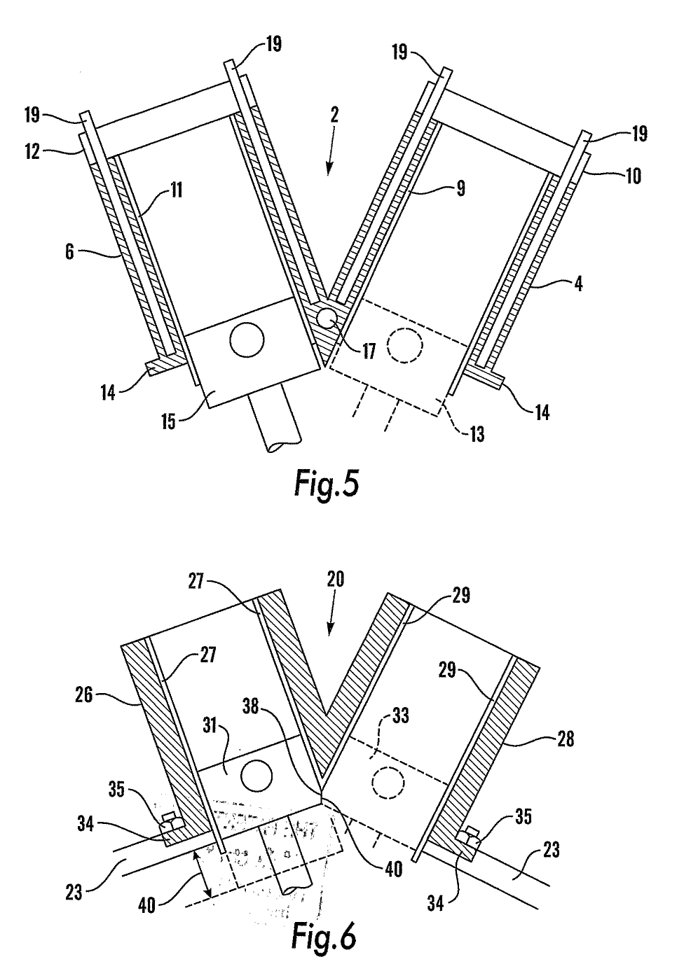

With reference to FIGS. 1 and 5, there is shown a known prior art v-twin type engine 2. The engine 2 comprises two separate cylinder bodies 4, 6 and a crankcase 8. The cylinder bodies 4, 6 each comprise respective cylinder heads 10, 12 and are each formed with internal cylinder chambers. The crankcase 8 is formed with a deck 14 that extends upwardly from the upper surface of the crankcase 8. The deck 14 comprises two sloped regions 16, 18, which act as attachment regions for the respective cylinder bodies 4, 6. The cylinder bodies 4, 6 each comprise a respective cylindrical sleeves 9, 11. The deck 14 is an integral part of the crankcase 8.

The cylinder heads 10, 12 and the cylinder bodies 4, 6 are attached to sloped regions 16, 18 of the deck 14 by a number of bolts 19 (see FIG. 5) that each extend through the cylinder heads 10, 12 and through the cylinder bodies 4, 6 and into the deck 14. FIG. 5 shows two piston heads 13, 15 at their respective lowest point i.e. at bottom dead centre. At bottom dead centre of the pistons there is a diamond shaped portion 17 of the casing located between piston heads 13, 15. The details of this standard type of v-engine design is well known to the skilled person.

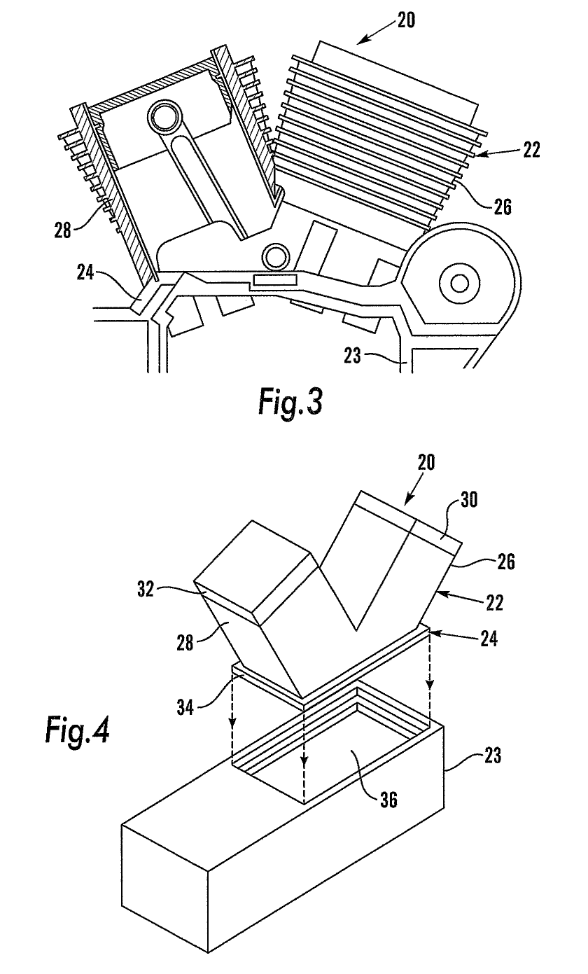

With reference to the FIGS. 2, 3, 4 and 6, there is shown a v-twin type engine 20 according to the present invention, the engine 20 comprises a v-twin cylinder block 22 and a crankcase 23. The cylinder block 22 is formed with two integral cylinders 26, 28 and a lower connection region 24 adapted to be attachable to the crankcase 23 of the engine 20. Disposed at the top of each cylinder 26, 28 there is a cylinder head 30, 32. Disposed within each cylinder 26, 28 there is a respective cylindrical cylinder sleeve 27, 29. The cylinder block 22 and the crank case 23 may be manufactured by a metal casting process or alternatively they may be machined using computer numerical control (CNC) apparatus. The engine 20 may be air cooled or alternatively the engine 20 may be water cooled.

The engine 20 comprises two pistons 31, 33. The lower cylindrical skirts of the pistons 31, 33 are each formed with a cutout portion 38, 39. The cutout portions 38, 39 prevent the pistons 31, 33 from touching when they are at the bottom of their strokes.

The lower connecting region 24 is formed with a flange 34 that extends around the lower perimeter of the cylinder block 22. The flange 34 is received by an opening 36 formed in the crankcase 23. It will be appreciated that the flange 34 will follow the contours of the opening 36 and the crankcase 23. The flange 34 forms a seal with the crankcase 23. The flange 34 is formed with a series of holes through which extend securing bolts 35. The securing bolts 35 extend into treaded bores formed in the crankcase 23.

By having the connection of the cylinder block 22 to the crankcase 23 at the lower region 24 there is no need to have long bolts passing through the length of the cylinders 26, 28. Also, there is no need to have a deck 14 formed on the crankcase 23. By not having the deck feature a much greater cylinder bore can be provided whilst maintaining a standard stroke length and overall height if the cylinder block. Also, because the cylinder walls do not have to accommodate any securing bolts the wall thickness may be reduced and the bore of the cylinders may be increased whilst retaining the same appearance as a standard known engine. This means a greater engine capacity may be provided but retaining the standard overall appearance.

In order to maintain the appearance of a standard v-type engine and retain the stroke length of the pistons it may be necessary to reduce the cylinder head depth and raise each of the bottom dead centre points of the pistons. As the bore of the cylinders is increased, the pistons will be become closer together at the bottom of their strokes and this would require a larger cutout section in the piston skirts. However, the requirement for larger cutouts is prevented by reducing the thickness of the cylinder head height and the raising of the bottom dead centre of the piston stroke the pistons. The raised position 40 of the bottom dead centre of the piston from a standard engine is shown in FIG. 6. A typical amount for the raised position 40 could be 15 mm. To retain the standard stroke the depth of the cylinder head would be reduced by the same value as the raised position 40, i.e. 15 mm.

It shall be appreciated that while it is desirable to retain the overall appearance of a standard v-type engine, particularly when custom fitting a new engine in a standard bike frame, the height of the engine according to the present invention may be increased.

Below are some typical values of the larger bore engines which may be achieved using the present invention which have a standard stroke.

| | | Standard | 4 inch | 4.25 inch | 4.625 inch |
|---|---|---|---|---|---|
| Cylinder | | Cylinder | stroke | stroke | stroke |
| diameter | | capacity | length | length | length |
| 3.5 | inches | 1203 cc | 1261 cc | 1340 cc | 1458 cc |
| 3.625 | inches | 1285 cc | 1353 cc | 1437 cc | 1564 cc |
| 3.75 | inches | 1375 cc | 1448 cc | 1538 cc | 1674 cc |
| 3.875 | inches | 1468 cc | 1546 cc | 1642 cc | 1787 cc |
| 4.0 | inches | 1565 cc | 1647 cc | 1750 cc | 1905 cc |
| 5.0 | inches | 2445 cc | 2574 cc | 2735 cc | 2976 cc |
| 3.8 | inches | 1412 cc | 1486 cc | 1579 cc | 1719 cc |
| 4.5 | inches | 1981 cc | 2085 cc | 2215 cc | 2411 cc |

1. A v-twin cylinder block for motorcycle engine comprising a crankcase, the v-twin cylinder block comprising a single block formed with two cylinders and lower connection region adapted to be attachable to the crankcase of the engine.

2. A v-twin cylinder block as claimed in claim 1, wherein the lower connection region is adapted to be received by an opening formed in the crankcase of the engine.

3. A v-twin cylinder block as claimed in claim 1, wherein the v-twin cylinder block is attachable to the crankcase by means disposed at the lower connection region.

4. A v-twin cylinder block as claimed in claim 1, wherein the cylinders of v-twin cylinder block are formed at a 45 degree angle to each other.

5. A v-twin cylinder block as claimed in claim 1, wherein the lower connection region comprises a flange that extends outwardly from the lower perimeter of the cylinder block.

6. A v-twin cylinder block as claimed in claim 1, wherein the cylinder block is a single casting from a metal material.

7. A v-twin cylinder block as claimed in claim 1, wherein each cylinder of the cylinder block comprises a cylinder head part which is securable to the uppermost end of the respective cylinders.

8. A v-twin cylinder block as claimed in claim 7, wherein each cylinder head part is preferably secured to the respective cylinder by a series of removable securing elements which extend partially through cylinder block.

9. A crankcase for a motorcycle engine comprising a v-twin cylinder block as claimed in claim 1, wherein the crankcase is formed with an opening adapted to receive, and attachable to, the lower region of the cylinder block.

10. A crankcase as claimed in claim 9, wherein the opening is substantially a rectangular shape which follows the contours of the crankcase.

11. A method of producing a hologram comprising the steps of: forming an holographic optical element (HOE) array; overlaying, in registration with said array, an intensity modulated image filter, adapted to modify the intensity of light transmitted through the holographic optical elements of the array.

12. A method for adapting a standard v-type engine and increasing the capacity of the standard engine and maintaining the standard stroke length of the cylinder block, wherein the method comprises replacing the individual cylinders with a single cylinder block formed with the respective cylinders.

13. An engine comprising a cylinder block and a crankcase, the cylinder block comprising a single block formed with two cylinders and a lower connection region adapted to be received by an opening formed in the crankcase of the engine.
